(19) United States
(12) Patent Application Publication
(10) Pub. No.: US 2009/0252116 A1
(43) Pub. Date: Oct. 8, 2009

(54) Multiple Action Times in Mobile WiMAX Fast Handover

(75) Inventors: Achim von Brandt, Munich (DE); Sandro Grech, Helsinki (FI); Roman Pichna, Espoo (FI); Aik Chindapol, Washington, DC (US)

Correspondence Address: KING & SPALDING, 1185 AVENUE OF THE AMERICAS, NEW YORK, NY, 10036-4003, US

(73) Assignee: NOKIA SIEMENS NETWORKS GMBH & CO. KG, Munich (DE)

(21) Appl. No.: 12/098,156

(22) Filed: Apr. 4, 2008

(51) Int. Cl. H04Q 7/00

(52) U.S. Cl. 370/331

(57) ABSTRACT

A base station and a method for handover of a mobile station from a serving base station to a target base station of a mobile telecommunication network. Invitations may be sent from a base station to the mobile station, and the invitations may be invitations to send a request for a fast handover procedure from the mobile station to a base station.

### FIELD OF THE INVENTION

The invention concerns methods, apparatus and computer-readable media for handover of a mobile station in a network, and particularly in a WiMAX network.

### BACKGROUND

WiMAX (Worldwide Interoperability for Microwave Access) is a known technology for wireless telecommunication networks. WiMAX specifications are available on the internet, for example at http://www.wimaxforum.org and http://en.wikipedia.org/wiki/WiMAX.

When connecting to a target base station (BS) during a handover (HO) procedure (also known in the art as “handoff”), a mobile station (MS) has to go through a ranging process, which by definition is a contention-based process (e.g. a contention, based on priorities, of mobile stations which request a handover to a target base station). This contention adds latency. This latency can be avoided by allocating dedicated fast ranging opportunities to the MS. This fast handover procedure is supported by the IEEE 802.16e standard and WiMAX NWG Re1. 1.

The term “Action Time” is used herein to indicate the period of time (e.g. Action Time #1) during which a target base station (T-BS) gives dedicated fast ranging opportunity to a mobile station (MS) in a fast handover (HO) process. If the MS misses the opportunity to send a fast ranging request in the dedicated time slot in the frame indicated by the Action Time, it has to default to normal (slow) handover with CDMA ranging which is contention-based and thus adds considerable latency. A possible remedy is to set large values for Action Time to allow most fast handovers to succeed. The value of the Action Time used will depend on MS implementation and configuration (e.g., T55 timer) and network latencies.

### SUMMARY OF THE INVENTION

In one aspect, the invention provides a method of handover of a mobile station from a serving base station to a target base station of a mobile telecommunication network. The method may comprise the step of sending invitations from a base station to the mobile station, where the invitations are invitations to send a request for a fast handover procedure from the mobile station to a base station. The mobile telecommunication network may be a WiMAX telecommunication network. The method may further include the step of sending a request for a fast handover procedure, which request is a ranging request message. The fast handover procedure may be a handover procedure without contention. The fast handover procedure may also be a procedure according to IEEE 802.16e. The method may further include the step of setting timer values, where timer values sent from a base station to the mobile station represent times at which respectively a target base station will send an invitation for a fast handover to the mobile station. At least two invitation messages may be sent to the mobile station from at least two base stations respectively. More than one fast handover invitation message may be sent to the mobile station from each base station, which is a target for a handover of the mobile station. More than one time may be sent to the mobile station from each target base station, which is a target for a handover of the mobile station. A target base station may send invitations offering fast handover opportunities to a mobile station, until either the mobile station accepts an opportunity for a fast handover offered in an invitation in a time slot related to this fast handover opportunity, or the mobile station starts a ranging for a handover. A target base station may stop offering further fast handover opportunities to that mobile station when a mobile station accepted an opportunity for a fast handover offered in an invitation within a time slot related to this fast handover opportunity, or when a mobile station starts a CDMA ranging for a handover. Timer values may indicate the times when opportunities for fast handover of a mobile station will be offered in an invitation, are signaled from one or more than one target base station, to which a handover is possible, to a serving base station with which the mobile station is connected before the handover. Timer values may indicate the times when opportunities for fast handover of a mobile station will be offered in an invitation, are signaled from a base station, with which the mobile station is connected before the handover, to the mobile station. Timer values, indicating the times when opportunities for fast handover of a mobile station will be offered in an invitation, are signaled from a serving base station, with which the mobile station is connected before the handover, to the mobile station in a MOB_BSHO-RSP or MOB_BSHO_REQ message. The request for a fast handover procedure is a fast ranging request. Timer values are signaled as at least one of a list of discrete action times; a list of pairs including respectively a timer value and a target base station identity; a list of bursts, each being denoted by the start instant and number of instances; and a list of bursts each being denoted by the start of burst, end of burst and the frequency of action times; where a broadcast of fast ranging opportunities follows a standardized procedure.

In another aspect, the invention provides a computer-readable medium storing instructions which, when executed by a computer, cause the computer to perform the step of sending invitations from a base station to the mobile station, where the invitations are invitations to send a request for a fast handover procedure from the mobile station to a base station.

In yet another aspect, the invention provides a base station for a mobile telecommunication network. The base station may comprise a sender for sending an invitation for a request for a fast handover procedure to a mobile station, timers for measuring the times at the end of which respectively an invitation for a request for a fast handover procedure is to be sent to the mobile station by the sender, and a controller for requesting the sender to send an invitation when a timer signals that the time measured by a timer expired. Times measured by timers and to be sent from a base station to the mobile station may represent times at which respectively a target base station is requested to send an invitation to send a request for a fast handover to the mobile station. The sender may send at least two invitations to the mobile station. The sender of the base station may send invitations offering fast handover opportunities to a mobile station, until either the mobile station accepts an opportunity for a fast handover offered in an invitation in a time slot related to this fast handover opportunity, or the mobile station starts a ranging for a handover. Timer values indicating the times when opportunities for fast handover of a mobile station may be offered in an invitation, are signaled from the base station, which is connected to the mobile station before the handover, to the mobile station. Timer values indicating the times when opportunities for a fast handover of a mobile station may be offered in an invitation, are signaled from a serving base station, with which the mobile station is connected before the handover, to the mobile station.

### BRIEF DESCRIPTION OF THE DRAWINGS

Other aspects, features and advantages of the present invention will become more fully apparent from the following detailed description in conjunction with the appended drawings, in which:

FIG. 1 shows a prior art WiMAX reference architecture.

FIG. 2 shows a mobile station moving in a WiMAX access network in an embodiment of the invention.

FIG. 3 shows a signaling diagram of a fast handover procedure using a plurality of action times in an embodiment of the invention.

FIG. 4 shows a block diagram of a base station in an embodiment of the invention.

Drawings are only diagrammatic and not to scale. Corresponding elements in different drawings are indicated by the same numerals.

### DETAILED DESCRIPTION

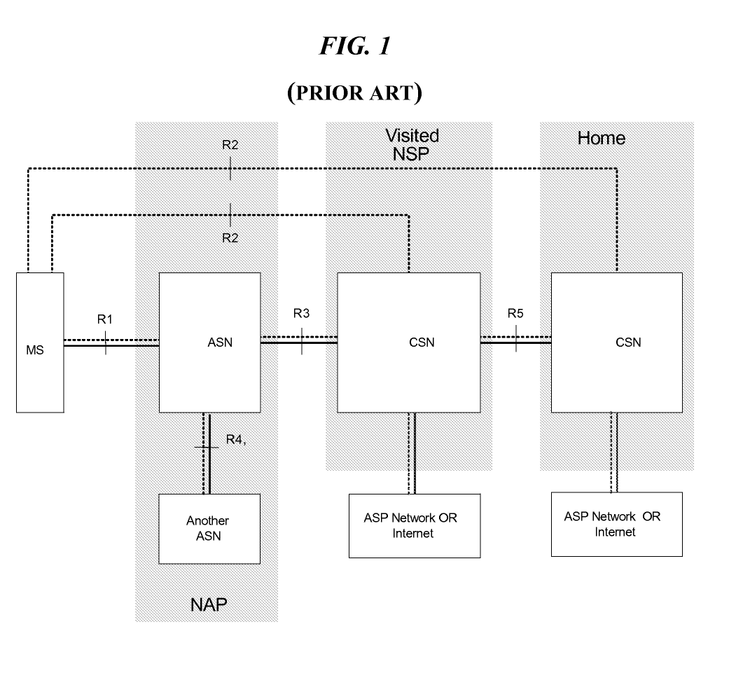

FIG. 1 shows a prior art WiMAX reference architecture. As discussed above, the WiMAX specifications are publicly available. Therefore details of telecommunication networks which are not very relevant for understanding the invention are not explained here in detail.

In FIG. 1, a mobile station MS of a subscriber communicates via an air interface R1 with an access service network ASN, the access service network entity ASN communicates via an interface R3 with a Connectivity Service Network (CSN) entity CSN of a visited network of a service provider NSP, which communicates via an interface R5 with a Connectivity Service Network (CSN) entity CSN of a home network of a service provider NSP. Further there are interfaces (via further components) R2 for communication of the mobile station MS with an entity of the home network Home NSP and for communication of the visited NSP's CSN entities with an ASP network or internet and for communication of the home NSP's CSN entities with an ASP network or internet.

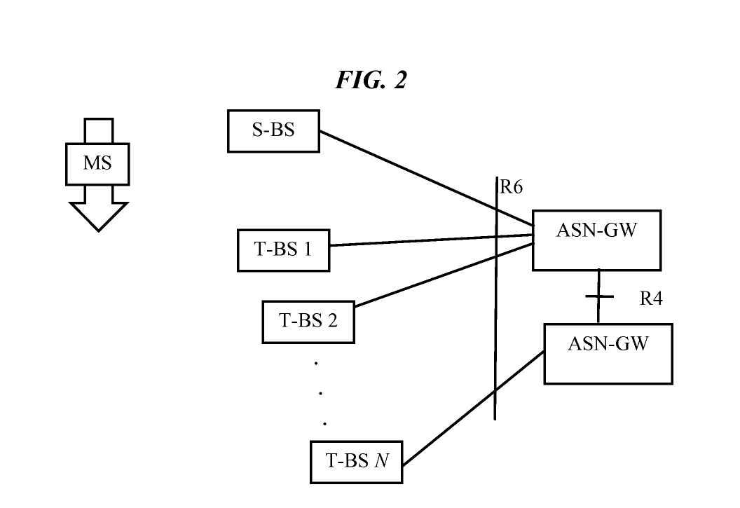

FIG. 2 shows a mobile station moving in a WiMAX access network in an embodiment of the invention. Base stations BS are connected to access network entities (gateways) ASN-GW of an access network via the interface R6. If there are several access service network gateways ASN-GWs, they are interconnected with each other via the interface R4.

In FIG. 2 a mobile station MS is moving (in the direction of the arrow) and therefore handing over from its current Serving Base Station (S-BS) to one of the Target Base Stations T-BS 1 through T-BS N. The term “handing over” or “handover” means that the mobile station MS is sending/receiving user data (speech data, internet data etc) from/to a first base station (Serving Base Station (S-BS)) before handing over; and from/to a second base station (one of the Target Base Stations (T-BSs)) after handing over. The handover process and related related processes are known from WiMAX specifications and will not be described in detail.

In a conventional implementation, Target Base Stations T-BS 1 through N would only set one “Action Time.” At this time, the mobile station is offered by a base station to perform a fast handover without contention. However this would result in a high number of handover failures if the “Action Time” time limit is too short, i.e. if this time comes to soon after having been announced. Alternatively, the conventional implementation may result in long handover delays if the “Action Time” time limit is too long.

According to an embodiment of the invention, more than one “Action Time” may be set for a mobile station MS for at least one target base station T-BS, or for each target base station T-BS the mobile station MS could move to.

According to an embodiment of the invention, one or more action times may be used for each target base station T-BS. These multiple action time values may be signaled from a target base station T-BS to a serving base station S-BS in a R6/R4 HO_Rsp (Handover Response) signal, TBD in NWG Re1. 1 Ver. 1. Signaling of these multiple action time values from the serving base station S-BS to a mobile station MS can be done across a R1 interface in, e.g. a MOB_BSHO-RSP message or in a MOB_BSHO-REQ (TBD in 802.16e-Rev2) message for mobile-triggered or network-triggered handover respectively.

A target base station T-BS may stop the broadcast of fast ranging opportunities for a particular mobile station MS if that mobile station MS has succeeded in using one opportunity. A target base station T-BS may also stop the broadcast of fast ranging opportunities for a particular mobile station MS if that mobile station MS has reverted to a conventional contention-based ranging for handover process.

In an embodiment of the invention, action times may be signaled as:
a list of discrete action times;
a list of pairs (T-BS ID, Action Time) where the same T-BS ID may show up in more than one pair;
a list of bursts, each being denoted by the start instant and number of instances;
a list of bursts, each being denoted by the start of burst, end of burst and the frequency of action times.

The broadcast of fast ranging opportunities may follow a standardized formula (in 802.16e-Rev2), e.g., an exponentially-growing inter-Action Time spacing, etc., and the size of broadcast window or number of broadcast instance.

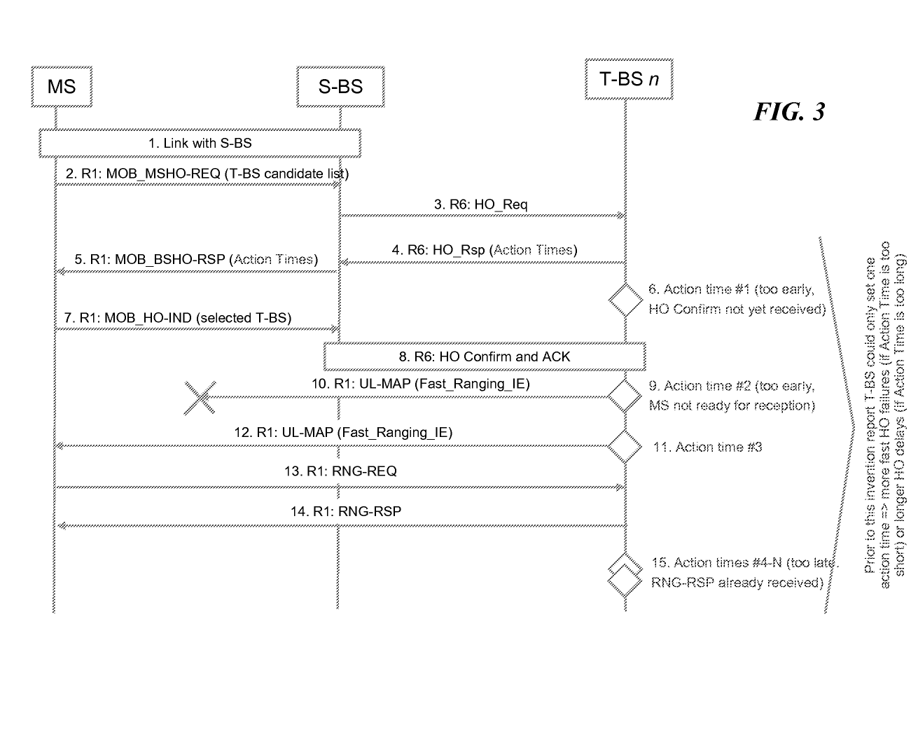

FIG. 3 shows a signaling diagram of a fast handover procedure using a plurality of action times in an embodiment of the invention. The steps are explained in the following:

Step 1: A mobile station MS is still attached to a serving base station S-BS. Then the mobile station MS moves (as shown by the arrow in FIG. 2) and a handover of the mobile station to a target base station with adequate radio connection to the mobile station should be done.

Step 2: The mobile station MS initiates handover (HO) and signals a list of candidate target base stations T-BS 1 through T-BS n and an indication that it can do/requests to do a fast handover procedure.

Step 3: The serving base station S-BS signals the request to target base station T-BS 1 through T-BS n.

Step 4: The target base stations T-BS reply to the serving base station S-BS and indicate a plurality of Action Times (e.g., #1, #2, #3, #4 through #N) at which times respectively a fast handover is possible.

Step 5: The serving base station S-BS collects and forwards the list of target base stations T-BS, each with the associated lists of Action Times.

Step 6: Action time #1 timer expires in a target base station T-BS n. It timed out too early, i.e. before a HO confirm message has been received by the target base station T-BS n. The target base station T-BS does not allocate any fast ranging opportunity for the mobile station MS at this action time #1.

Step 7: A mobile station MS makes a decision and signals an identity of the target base station T-BS selected by the mobile station to the serving base station S-BS.

Step 8: The serving base station S-BS forwards this decision in a signal to the selected T-BS.

Step 9: Action time #2 timer expires in the target base station T-BS n.

Step 10: Action time #2 expired too early for the mobile station MS to receive the UL-MAP broadcast carrying the fast ranging opportunity. The mobile station MS is not yet ready.

Step 11: Action time #3 expires in the target base station T-BS.

Step 12: The target base station T-BS allocated fast ranging opportunity to the mobile station MS and broadcasts it in a UL-MAP message.

Step 13: The mobile station MS sends a ranging request in the allocated fast ranging (time) slot.

Step 14: The target base station T-BS n replies according to the WiMAX standard.

Step 15: Subsequent Action Time timers expire in the target base station T-BS but no fast ranging opportunity is allocated or broadcast since the target base station T-BS is already aware of the mobile station MS having used the opportunity #3.

While the above steps have been described with specific technical details, it will be apparent that the procedure is only illustrative and not limiting of the invention.

An embodiment of the invention allows for multiple action times for each target base station T-BS n in a fast handover procedure. These can be set to represent, e.g., fastest possible HO action time, expected fast HO action time, conservative HO action time (still faster than normal network re-entry).

A target base station T-BS n will send multiple action time opportunities for the mobile station MS fast handover. They are signaled via R4 and R6 interfaces in a HO_Rsp signal (TBD in NWG Re1. 1 Ver. 1.2) from a target base station T-BS to a serving base station S-BS. Then they are signaled via R1 e.g. in a MOB_BSHO-RSP or MOB_BSHO-REQ (TBD in 802.16e-Rev2) signal to the mobile station MS for mobile- or network-triggered handover respectively.

Once a mobile station MS used the first opportunity or obviously has ignored it by starting CDMA ranging (normal, slow HO), a target base station T-BS will not give further fast ranging opportunities to that mobile station MS.

As an alternative to listing action time instants, action times can be announced in bursts wherein only the first one and number of following ones are signaled. As another alternative to listing action times, a formula may be employed for distributing Action Time events after the first one, e.g., exponentially increasing inter-Action Time spacing.

In an embodiment of the invention, the procedure crosses a radio interface and it could be standardized in IEEE 802.16e, Rev. 2 and/or in NWG Re1. 1 CR.

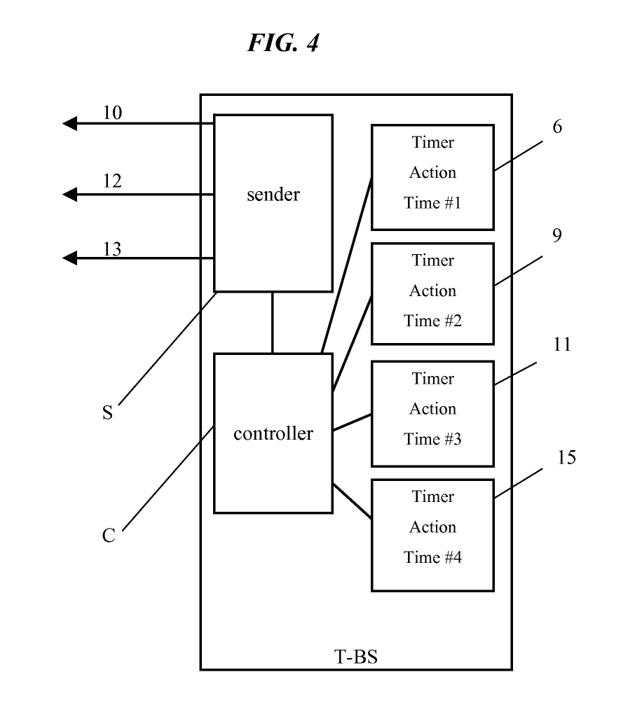

FIG. 4 shows a block diagram of a base station in an embodiment of the invention. The base station may include a sender S controlled by a controller C and with several timers 6, 9, 11 and 15. When an Action Time timer 9 times out, the controller C triggers the sender S to send one or more invitation messages (ranging opportunity) 10, 12, 13 to the mobile station MS.

What has been described above is what is presently considered to be a preferred embodiment of the present invention. However, as is apparent to the skilled reader, such embodiment is provided for illustrative purposes, and the invention is in no way restricted to that particular embodiment. Accordingly, numerous alternatives, modifications, and variations are possible within the scope of the appended claims.

### LIST OF ABBREVIATIONS

WiMAX Worldwide Interoperability for Microwave Access

MS Mobile Station

BS Base Station

S-BS Serving Base Station

T-BS Target Base Station

TBD To Be Done

CDMA Code Division Multiple Access

HO Handover or handoff

ASN Access Service Network

ASN-GW Access Service Network Gateway (belongs to ASN)

R1-R5, R8 Interconnections between SS/MSS, ASN, CSNs

R6 Interconnections between S-BS/TBS (1-n) and ASN-GW

R4 Interconnection between two ASN-GWs

CSN Connectivity Service Network

HA Home Agent, belongs to CSN

AAA Authentication, Authorization and Accounting (AAA Server belongs to CSN)

NAP Network Access Provider

NSP Network Service Provider

What is claimed is:

1. A method of handover of a mobile station from a serving base station to a target base station of a mobile telecommunication network, the method comprising:
sending invitations from a base station to the mobile station;
wherein the invitations are invitations to send a request for a fast handover procedure from the mobile station to a base station.

2. The method of claim 1, wherein the mobile telecommunication network is a WiMAX telecommunication network.

3. The method of claim 1, further including:
sending a request for a fast handover procedure, which request is a ranging request message.

4. The method of claim 1, wherein the fast handover procedure is a handover procedure without contention.

5. The method of claim 1, wherein the fast handover procedure is a procedure according to IEEE 802.16e.

6. The method of claim 1, further including:
setting timer values,
wherein timer values sent from a base station to the mobile station represent times at which respectively a target base station will send an invitation for a fast handover to the mobile station.

7. The method of claim 1, wherein at least two invitation messages are sent to the mobile station from at least two base stations respectively.

8. The method of claim 1, wherein more than one fast handover invitation message is sent to the mobile station from each base station, which is a target for a handover of the mobile station.

9. The method of claim 1, wherein more than one time is sent to the mobile station from each target base station, which is a target for a handover of the mobile station.

10. The method of claim 1, wherein a target base station sends invitations offering fast handover opportunities to a mobile station, until either the mobile station accepts an opportunity for a fast handover offered in an invitation in a time slot related to this fast handover opportunity, or the mobile station starts a ranging for a handover.

11. The method of claim 1, wherein a target base station will stop offering further fast handover opportunities to that mobile station when a mobile station accepted an opportunity for a fast handover offered in an invitation within a time slot related to this fast handover opportunity, or when a mobile station starts a CDMA ranging for a handover.

12. The method of claim 1, wherein timer values indicating the times when opportunities for fast handover of a mobile station will be offered in an invitation, are signaled from one or more than one target base station, to which a handover is possible, to a serving base station with which the mobile station is connected before the handover.

13. The method of claim 1, wherein timer values indicating the times when opportunities for fast handover of a mobile station will be offered in an invitation, are signaled from a base station, with which the mobile station is connected before the handover, to the mobile station.

14. The method of claim 1, wherein timer values, indicating the times when opportunities for fast handover of a mobile station will be offered in an invitation, are signaled from a serving base station, with which the mobile station is connected before the handover, to the mobile station in a MOB_BSHO-RSP or MOB_BSHO_REQ message.

15. The method of claim 1, wherein the request for a fast handover procedure is a fast ranging request.

16. The method of claim 1, wherein timer values are signaled as at least one of:
a list of discrete action times;
a list of pairs including respectively a timer value and a target base station identity;
a list of bursts, each being denoted by the start instant and number of instances; and
a list of bursts each being denoted by the start of burst, end of burst and the frequency of action times;
wherein a broadcast of fast ranging opportunities follows a standardized procedure.

17. A computer-readable medium storing instructions which, when executed by a computer, cause the computer to perform the step of:
sending invitations from a base station to the mobile station;
wherein the invitations are invitations to send a request for a fast handover procedure from the mobile station to a base station.

18. A base station for a mobile telecommunication network, the base station comprising:
a sender for sending an invitation for a request for a fast handover procedure to a mobile station,
timers for measuring the times at the end of which respectively an invitation for a request for a fast handover procedure is to be sent to the mobile station by the sender,
a controller for requesting the sender to send an invitation when a timer signals that the time measured by a timer expired.

19. The base station of claim 18, wherein the mobile telecommunication network is a WiMAX telecommunication network.

20. The base station of claim 18, wherein the request for a fast handover procedure is a ranging request message.

21. The base station of claim 18, wherein the fast handover procedure is a handover procedure without contention.

22. The base station of claim 18, wherein the fast handover procedure is a procedure according to IEEE 802.16e.

23. The base station of claim 18, wherein times measured by timers and to be sent from a base station to the mobile station represent times at which respectively a target base station is requested to send an invitation to send a request for a fast handover to the mobile station.

24. The base station of claim 18, wherein the sender sends at least two invitations to the mobile station.

25. The base station of claim 18, wherein the sender of the base station sends invitations offering fast handover opportunities to a mobile station, until either the mobile station accepts an opportunity for a fast handover offered in an invitation in a time slot related to this fast handover opportunity, or the mobile station starts a ranging for a handover.

26. The base station of claim 18, wherein the base station will stop offering further fast handover opportunities to that mobile station when a mobile station accepted an opportunity for a fast handover offered in an invitation within a time slot related to this fast handover opportunity, or when a mobile station starts a CDMA ranging for a handover.

27. The base station of claim 18, wherein timer values indicating the times when opportunities for a fast handover of a mobile station will be offered in an invitation, are signaled from a target base station, to which a handover is possible, to a serving base station with which the mobile station is connected before the handover.

28. The base station of claim 18, wherein timer values indicating the times when opportunities for fast handover of a mobile station will be offered in an invitation, are signaled from the base station, which is connected to the mobile station before the handover, to the mobile station.

29. The base station of claim 18, wherein timer values indicating the times when opportunities for a fast handover of a mobile station will be offered in an invitation, are signaled from a serving base station, with which the mobile station is connected before the handover, to the mobile station.

30. The base station of claim 18, wherein the request for a fast handover procedure is a fast ranging request.

31. The base station of claim 18, wherein timer values are signaled as at least one of:
a list of discrete action times;
a list of pairs including respectively a timer value and a target base station identity;
a list of bursts, each being denoted by the start instant and number of instances; and
a list of bursts each being denoted by the start of burst, end of burst and the frequency of action times;
wherein a broadcast of fast ranging opportunities follows a standardized procedure.
